(19) United States
(12) Patent Application Publication
(10) Pub. No.: US 2006/0007223 A1
(43) Pub. Date: Jan. 12, 2006

(54) Display control system and method

(76) Inventor: Jeffrey C. Parker, Magnolia, TX (US)

Correspondence Address: HEWLETT-PACKARD COMPANY;Intellectual Property Administration, P.O. Box 272400, Fort Collins, CO, 80527-2400, US

(21) Appl. No.: 10/888,060

(22) Filed: Jul. 9, 2004

(51) Int. Cl. G09G 5/00

(52) U.S. Cl. 345/207

(57) ABSTRACT

A display control system comprises a display controller adapted to detect an ambient light condition about an electronic device. The display controller is also adapted to determine an optical response characteristic associated with the ambient light condition and automatically adjust a brightness of a display of the electronic device based on the optical response characteristic.

### BACKGROUND

Electronic devices, such as portable telephones, notebook or laptop computers, projectors, personal digital assistants, desktop computers, televisions, and others, are generally configured to display an image using a variety of different methods (e.g., liquid crystal display (LCD), cathode-ray tube (CRT), etc.). Additionally, the environments in which such electronic devices are used greatly vary. For example, such electronic devices are generally capable of being used indoors and/or outdoors, thereby resulting in varied lighting conditions in which to use the electronic device. Further, lighting conditions may also change within a particular environment (e.g., lights dimmed or tuned off indoors; setting sun or cloudy conditions outdoors). Thus, maintaining image quality and visibility under varied lighting conditions is problematic for electronic devices.

### SUMMARY OF THE INVENTION

In accordance with one embodiment of the present invention, a display control system comprises a display controller adapted to detect an ambient light condition about an electronic device. The display controller is also adapted to determine an optical response characteristic associated with the ambient light condition and automatically adjust a brightness of a display of the electronic device based on the optical response characteristic.

In accordance with another embodiment of the present invention, a display control system comprises a display controller adapted to detect an ambient light condition about an electronic device. The display controller is also adapted to determine an optical response characteristic associated with the ambient light condition and automatically adjust a color balance of an image displayed by the electronic device based on the optical response characteristic.

In accordance with another embodiment of the present invention, a display control system comprises a display controller adapted to detect a change in an ambient light condition about an electronic device. The display controller is also adapted to determine an optical response characteristic associated with the change in the ambient light condition and automatically adjust a rate of brightness change of a display of the electronic device based on the optical response characteristic.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of a display control system in accordance with the present invention;

FIG. 2 is a flow diagram illustrating an embodiment of a display control method in accordance with the present invention; and

FIG. 3 is a flow diagram illustrating another embodiment of a display control method in accordance with the present invention.

### DETAILED DESCRIPTION OF THE DRAWINGS

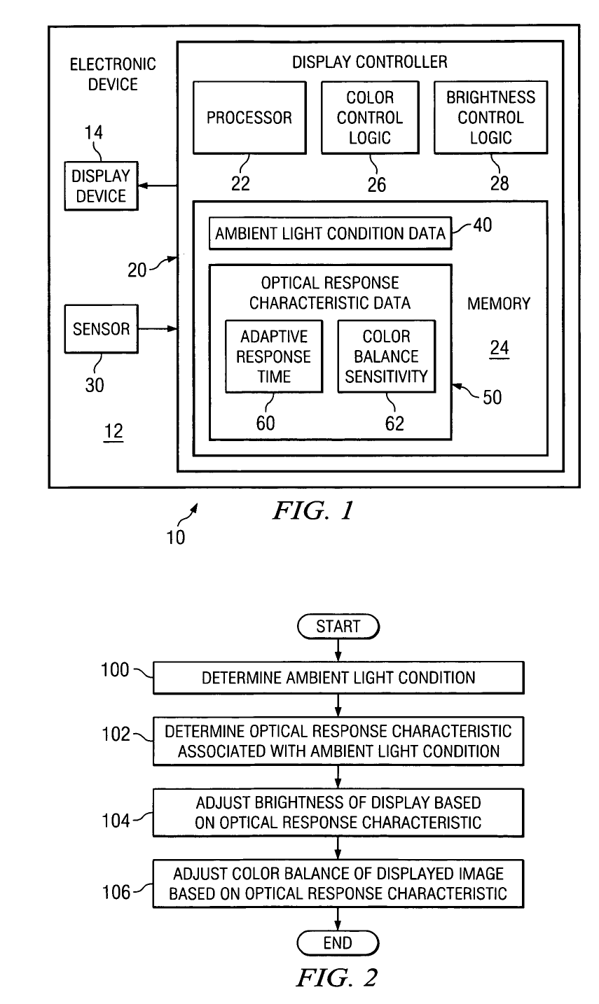

The preferred embodiments of the present invention and the advantages thereof are best understood by referring to FIGS. 1-3 of the drawings, like numerals being used for like and corresponding parts of the various drawings.

FIG. 1 is a diagram illustrating an embodiment of a display control system 10 in accordance with the present invention. Briefly, control system 10 controls and/or automatically adjusts a displayed image of an electronic device based on response characteristics of the human eye corresponding to ambient light conditions relative to the electronic device such as, but not limited to, the human eye's ability to adjust to changing light conditions (e.g., dark to light, and vice versa) and the human eye's ability to sense or perceive different colors under different lighting conditions.

In the embodiment illustrated in FIG. 1, system 10 comprises an electronic device 12 having a display device 14. Electronic device 12 may comprise any type of device configured for displaying an image such as, but not limited to, a laptop or notebook computer, personal digital assistant, telephone, camera, desktop computer, television, or a projector. Accordingly, display device 14 may comprise any type of device for displaying an image such as, but not limited to, a liquid crystal display (LCD) or cathode-ray tube (CRT), or plasma display panel.

In the embodiment illustrated in FIG. 1, electronic device 12 comprises a display controller 20 for controlling various characteristics of an image displayed by electronic device 12, such as via display device 14. In the embodiment illustrated in FIG. 1, display controller 20 comprises a processor 22, a memory 24, color control logic 26, and brightness control logic 28. Color control logic 26 and brightness control logic 28 may comprise software, hardware, or a combination of software and hardware. In operation, display controller 20 uses color control logic 26 and/or brightness control logic 28 to control the display of an image by electronic device 12, such as, but not limited to, color balance and brightness and/or contrast, based on ambient light conditions relative to electronic device 12 and based on optical response characteristics of the human eye. For example, in the embodiment illustrated in FIG. 1, electronic device 12 comprises a sensor 30 for detecting ambient light conditions relative to electronic device 12. Thus, based on ambient light conditions about electronic device 12, display controller 20 automatically adjusts display characteristics of a displayed image to accommodate optical response characteristics associated with the human eye.

In the embodiment illustrated in FIG. 1, memory 24 comprises ambient light condition data 40 and optical response characteristic data 50. Ambient light condition data 40 comprises information associated with ambient light conditions relative to electronic device 12, such as ambient light conditions detected by sensor 30. In some embodiments of the present invention, ambient light condition data 40 comprises information associated with ambient light conditions relative to electronic device 12 occurring over a predetermined time period such that a comparison of ambient light condition data 40 values is performed by display controller 20 to detect or otherwise identify changes to ambient light conditions relative to electronic device 12. Thus, in some embodiments of the present invention, display controller 20 dynamically controls a displayed image based on a human eye's response characteristics to changing light conditions.

Optical response characteristic data 50 comprises information associated with response characteristics of the human eye under different and/or changing light conditions. For example, different lighting conditions affect various functions of the human eye. For example, lighting conditions affect changes to the iris of the human eye such that the iris contracts or dilates to control the amount of light incident upon a retina of the human eye. The level of light also affects color perception or sensitivity of the human eye. Thus, in operation, optical response characteristic data 50 comprises information corresponding to human eye responsiveness related to various light conditions such that display controller 20 controls the display of an image based on human eye responsiveness to static and/or dynamic light conditions.

In the embodiment illustrated in FIG. 1, optical response characteristic data 50 comprises adaptive response time 60 and color balance sensitivity 62. Adaptive response time 60 comprises information associated with time periods for the human eye to react or respond to changes in lighting conditions. For example, light conditions from dark to light, and vise versa, increases or decreases, respectively, the sensitivity of the retina of the human eye and generally requires a particular time period for the human eye to adapt to the change in light conditions. Color balance sensitivity 62 comprises information associated with the ability of the human eye to sense or perceive various colors at different light conditions. For example, the human eye comprises two types of photoreceptors (cones and rods) which operate differently under different lighting conditions such as, but not limited to, photopic conditions (when light is plentiful) and scotopic conditions (when light is scarce). Thus, under different lighting conditions, the human eye senses or perceives colors differently and/or lacks the ability to sense or perceive particular colors. Accordingly, in the embodiment illustrated in FIG. 1, in operation, display controller 20 uses adaptive response time 60 and color balance sensitivity 62 to control display characteristics of a displayed image such that brightness and color balance and/or color contrast of an image displayed by electronic device 12 is adjusted based on a human eye responsiveness to static and/or dynamic light conditions.

Thus, in operation, display controller 20 controls a brightness and/or contrast of a displayed image and/or color balance of a displayed image based on human eye characteristics as defined by optical response characteristic data 50. For example, display controller 20 uses color control logic 26 to control a color balance of a displayed image of electronic device 12 based on optical response characteristic data 50 associated with ambient light conditions relative to electronic device 12 as detected by sensor 30. Display controller 20 also uses brightness control logic 28 to control a brightness and/or contrast of a displayed image of electronic device 12 using optical response characteristic data 50 corresponding to ambient light conditions as detected by sensor 30. In some embodiments of the present invention, display controller 20 dynamically controls the displayed image of electronic device 12 based on changes to ambient lighting conditions detected by sensor 30. For example, display controller 20, via color control logic 26 and/or brightness control logic 28, accesses optical response characteristic data 50, such as adaptive response time 60, to determine response characteristics of the human eye corresponding to changing light conditions such that variations to the displayed image are made at a rate corresponding to a rate of human eye responsiveness. Thus, in operation, display controller 20 controls a rate of brightness change and/or color balance change corresponding to human eye responsiveness to changing light conditions as defined by optical response characteristic data 50.

In operation, to control a color balance of a displayed image of electronic device 12, display controller 20 uses color control logic 26 to detect or otherwise identify static and/or dynamic lighting conditions relative to electronic device 12 and identify an optical response characteristic of the human eye based on the detected static and/or dynamic lighting conditions via optical response characteristic data 50. For example, in some embodiments of the present invention, display controller 20 uses control color logic 26 to access color balance sensitivity 62 indicating a perception or color sensitivity of the human eye in response to static and/or dynamic lighting conditions and adjusts the displayed image of electronic device 12 based on the optical response characteristic as defined by color balance sensitivity 62. For example, in some embodiments of the present invention, display controller 20 is configured to adjust hue levels or values of the displayed image based on the human eye's ability to sense or perceive various colors under the detected light conditions as indicated by optical response characteristic data 50. As described above, in response to dynamic light condition changes relative to electronic device 12, display controller 20 uses color control logic 26 to control a rate of color balance change of the displayed image by accessing adaptive response time 60 and determining the optical response characteristic associated human eye reaction time to dynamic lighting condition changes to adjust a rate of color balance change to the displayed image. Thus, in some embodiments of the present invention, display controller 20 is adapted to perform color balance changes at a rate corresponding to the human eye's response or reaction time to ambient light changes.

In operation, to control a brightness and/or contrast of a displayed image, display controller 20 uses brightness control logic 28 to detect or otherwise identify static and/or dynamic lighting conditions relative to electronic device 12 and identify an optical response characteristic of the human eye based on the detected static and/or dynamic ambient light conditions via optical response characteristic data 50 to control a brightness and/or contrast of a displayed image. As described above, for dynamic light condition changes relative to electronic device 12, display controller 20 uses brightness control logic 28 to access adaptive response time 60 to determine an optical response characteristic associated with time responsiveness of the human eye under dynamic light condition changes to control a rate of brightness and/or contrast change of the displayed image based on the dynamic ambient light conditions. Thus, in some embodiments of the present invention, display controller 20 is adapted to control a rate of brightness and/or contrast change of a display based on the human eye's response or reaction time to ambient light changes.

FIG. 2 is a flow diagram illustrating an embodiment of a display control method in accordance with the present invention. The method begins at block 100, where display controller 20 detects or otherwise determines an ambient light condition relative to electronic device 12 via sensor 30. At block 102, display controller 20 accesses optical response characteristic data 50 to determine an optical response characteristic associated with the human eye based on the detected ambient light condition. At block 104, display controller 20 adjusts a contrast and/or brightness of a displayed image of electronic device 12 based on the optical response characteristic corresponding to the detected ambient light condition. At block 106, display controller 20 adjusts a color balance of the displayed image of electronic device 12 based on the optical response characteristic associated with the detected ambient light condition.

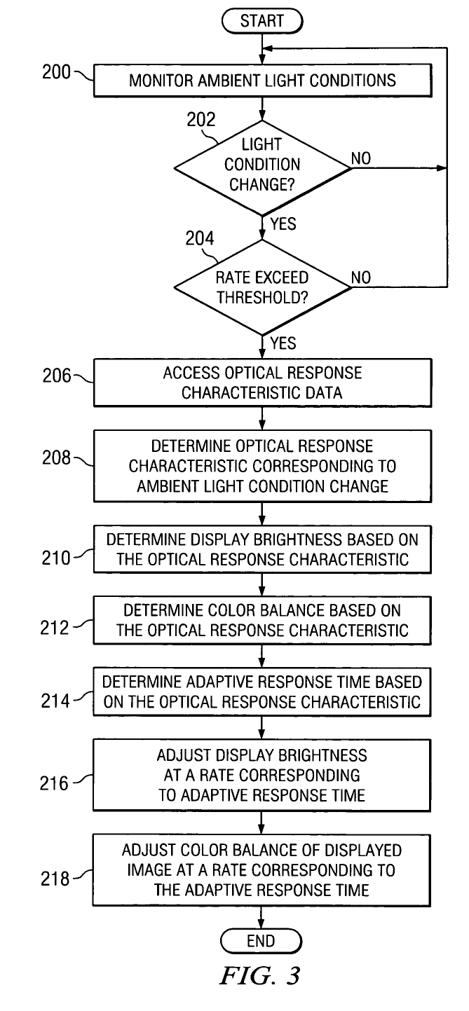

FIG. 3 is a flow diagram illustrating another embodiment of a display control method in accordance with the present invention. The method begins at block 200, where display controller 20 monitors ambient light conditions relative to electronic device 12 via sensor 30. At decisional block 202, a determination is made whether an ambient light condition change is detected. If an ambient light condition change is not detected, the method proceeds to block 200, where display controller 20 continues monitoring ambient light conditions. If an ambient light condition change is detected at block 202, the method proceeds to decisional block 204, where a determination is made whether a rate of the ambient light condition change exceeds a predetermined threshold. For example, in some embodiments of the present invention, display controller 20 is configured to adjust a rate of display characteristics change if a rate of ambient light condition change exceeds a predetermined threshold. If the rate of ambient light condition change does not exceed a predetermined threshold, the method proceeds to block 200, where display controller 20 continues monitoring ambient light conditions relative to electronic device 12. If a rate of ambient light condition change does exceed a predetermined threshold, the method proceeds to block 206, where display controller 20 accesses optical response characteristic data 50.

At block 208, display controller 20 determines an optical response characteristic corresponding to the detected ambient light condition change. At block 210, display controller 20 determines a display brightness for the display of electronic device 12 based on the optical response characteristic corresponding to the ambient light condition change. At block 212, display controller 20 determines a color balance for the displayed image based on the optical response characteristic corresponding to the ambient light condition change.

At block 214, display controller 20 determines an adaptive response time based on the optical response characteristic corresponding to the ambient light condition change. For example, as described above, display controller 20 accesses adaptive response time 60 to determine time responsiveness of the human eye in response to changing light conditions. At block 216, display controller 20 adjusts the brightness of a displayed image of electronic device 12 at a rate corresponding to the optical response characteristic as indicated by adaptive response time 60. At block 218, display controller 20 adjusts a color balance of the displayed image at a rate corresponding to the optical response characteristic as indicated by adaptive response time 60.

Thus, embodiments of the present invention enable automatic adjustment of a displayed image of an electronic device in response to static and/or dynamic light conditions based on human eye responsiveness to such light conditions. For example, embodiments of the present invention enable a brightness and/or contrast change to a displayed image to be mapped to human eye responsiveness to light conditions relative to the electronic device displaying the image. Additionally, embodiments of the present invention also enable a rate of brightness and/or contrast change to the displayed image to be controlled based on the human eye's rate of responsiveness or reaction to changing light conditions. Further embodiments of the present invention enable color adjustments or balancing of a displayed image based on the human eye's responsiveness to color at different light conditions. Embodiments of the present invention also enable a rate of color change to a displayed image to be controlled based on reaction time of the human eye to changes in light conditions. It should be understood that in the methods described in FIGS. 2 and 3, certain functions may be omitted, combined, or accomplished in a sequence different than depicted in FIGS. 2 and 3. Also, it should be understood that the methods depicted in FIGS. 2 and 3 may be altered to encompass any of the other features or aspects described elsewhere in the specification.

What is claimed is:

1. A display control system, comprising:
a display controller adapted to detect an ambient light condition about an electronic device, the display controller adapted to determine an optical response characteristic associated with the ambient light condition and automatically adjust a brightness of a display of the electronic device based on the optical response characteristic.

2. The system of claim 1, the display controller adapted to detect a change in the ambient light condition.

3. The system of claim 1, the display controller adapted to determine an optical response characteristic associated with a change in the ambient light condition.

4. The system of claim 1, the display controller adapted to automatically adjust the brightness of the display in response to a change in the ambient light condition based on an optical response characteristic associated with the change in the ambient light condition.

5. The system of claim 1, the display controller adapted to automatically adjust a color balance of an image displayed by the electronic device based on the optical response characteristic.

6. The system of claim 1, the display controller adapted to automatically adjust a rate of change to a color balance of an image displayed by the electronic device based on the optical response characteristic.

7. The system of claim 1, further comprising a sensor adapted to detect the ambient light condition.

8. The system of claim 1, the display controller adapted to monitor the ambient light condition about the electronic device.

9. The system of claim 1, the optical response characteristic indicating a human eye's adaptive response time corresponding to the ambient light condition.

10. The system of claim 1, the optical response characteristic indicating a human eye's color sensitivity corresponding to the ambient light condition.

11. A display control system, comprising:
means for determining an optical response characteristic associated with an ambient light condition about an electronic device; and
means for automatically adjusting a brightness of a display of the electronic device based on the optical response characteristic.

12. The system of claim 11, further comprising means for automatically adjusting a rate of change of brightness of the display based on the optical response characteristic.

13. The system of claim 11, further comprising means for automatically adjusting a color balance of an image displayed by the electronic device based on the optical characteristic.

14. The system of claim 11, further comprising means for automatically adjusting a rate of change to a color balance of an image displayed by the electronic device based on the optical response characteristic.

15. The system of claim 11, further comprising means for determining an optical response characteristic associated with a change in the ambient light condition.

16. A display control method, comprising:
determining an optical response characteristic associated with an ambient light condition about an electronic device; and
automatically adjusting a brightness of a display of the electronic device based on the optical response characteristic.

17. The method of claim 16, further comprising automatically adjusting a color balance of an image displayed by the electronic device based on the optical response characteristic.

18. The method of claim 16, further comprising automatically adjusting a rate of change to a color balance of an image displayed by the electronic device based on the optical response characteristic.

19. The method of claim 16, further comprising determining an optical response characteristic associated with a change in the ambient light condition.

20. The method of claim 16, wherein determining an optical response characteristic comprises obtaining information associated with a human eye's adaptive response time corresponding to the ambient light condition.

21. The method of claim 16, wherein determining an optical response characteristic comprises obtaining information associated with a human eye's color sensitivity corresponding to the ambient light condition.

22. A display control system, comprising:
a display controller adapted to detect an ambient light condition about an electronic device, the display controller adapted to determine an optical response characteristic associated with the ambient light condition and automatically adjust a color balance of an image displayed by the electronic device based on the optical response characteristic.

23. The system of claim 22, the display controller adapted to determine an optical response characteristic associated with a change in the ambient light condition.

24. The system of claim 22, the display controller adapted to automatically adjust a rate of change of the color balance based on the optical response characteristic.

25. The system of claim 22, the optical response characteristic indicating a human eye's adaptive response time corresponding to the ambient light condition.

26. The system of claim 22, the optical response characteristic indicating a human eye's color sensitivity corresponding to the ambient light condition.

27. The system of claim 22, further comprising a sensor adapted to detect the ambient light condition.

28. The system of claim 22, the display controller adapted to monitor the ambient light condition.

29. The system of claim 22, the display controller adapted to automatically adjust a rate of change of the color balance based on a rate of change to the ambient light condition.

30. A display control system, comprising:
means for determining an optical response characteristic associated with an ambient light condition about an electronic device; and
means for automatically adjusting a color balance of an image displayed by the electronic device based on the optical response characteristic.

31. The system of claim 30, further comprising means for determining an optical response characteristic associated with a change to the ambient light condition.

32. The system of claim 30, further comprising means for automatically adjusting a rate of change of the color balance based on the optical response characteristic.

33. The system of claim 30, wherein the determining means comprises means for obtaining information associated with a human eye's adaptive response time corresponding to the ambient light condition.

34. The system of claim 30, wherein the determining means comprises means for obtaining information associated with a human eye's color sensitivity corresponding to the ambient light condition.

35. A display control method, comprising:
determining an optical response characteristic associated with an ambient light condition about an electronic device; and
automatically adjusting a color balance of an image displayed by the electronic device based on the optical response characteristic.

36. The method of claim 35, further comprising determining an optical response characteristic associated with a change to the ambient light condition.

37. The method of claim 35, further comprising automatically adjusting a rate of change of the color balance based on the optical response characteristic.

38. The method of claim 35, further comprising monitoring the ambient light condition.

39. The method of claim 35, wherein determining an optical response characteristic comprises obtaining information associated with a human eye's adaptive response time corresponding to the ambient light condition.

40. The method of claim 35, wherein determining an optical response characteristic comprises obtaining information associated with a human eye's color sensitivity corresponding to the ambient light condition.

41. The method of claim 35, further comprising automatically adjusting a rate of change to the color balance based on a rate of change in the ambient light condition.

42. A display control system, comprising:
a display controller adapted to detect a change in an ambient light condition about an electronic device, the display controller adapted to determine an optical response characteristic associated with the change in the ambient light condition and automatically adjust a rate of brightness change of a display of the electronic device based on the optical response characteristic.

43. The system of claim 42, the display controller adapted to automatically adjust a color balance of an image displayed by the electronic device based on the optical response characteristic.

44. The system of claim 42, the display controller adapted to automatically adjust a rate of change to a color balance of an image displayed by the electronic device based on the optical response characteristic.

45. The system of claim 42, the optical response characteristic indicating a human eye's adaptive response time corresponding to the change in the ambient light condition.

46. The system of claim 42, the optical response characteristic indicating a human eye's color sensitivity corresponding to the ambient light condition.

47. A display control method, comprising:
determining an optical response characteristic associated with a change in an ambient light condition about an electronic device; and
automatically adjusting a rate of change to a brightness of a display of the electronic device based on the optical response characteristic.

48. The method of claim 47, further comprising automatically adjusting a color balance of an image displayed by the electronic device based on the optical response characteristic.

49. The method of claim 47, further comprising automatically adjusting a rate of change to a color balance of an image displayed by the electronic device based on the optical response characteristic.

50. The method of claim 47, wherein determining an optical response characteristic comprises obtaining information associated with a human eye's adaptive response time corresponding to the ambient light condition.

51. The method of claim 47, wherein determining an optical response characteristic comprises obtaining information associated with a human eye's color sensitivity corresponding to the ambient light condition.

52. A display control method, comprising:
means for determining an optical response characteristic associated with a change in an ambient light condition about an electronic device; and
means for automatically adjusting a rate of change to a brightness of a display of the electronic device based on the optical response characteristic.

53. The system of claim 52, further comprising means for automatically adjusting a color balance of an image displayed by the electronic device based on the optical response characteristic.

54. The system of claim 52, further comprising means for automatically adjusting a rate of change to a color balance of an image displayed by the electronic device based on the optical response characteristic.

55. The system of claim 52, wherein the means for determining an optical response characteristic comprises means for obtaining information associated with a human eye's adaptive response time corresponding to the change in the ambient light condition.

56. The system of claim 52, wherein the means for determining an optical response characteristic comprises means for obtaining information associated with a human eye's color sensitivity corresponding to the ambient light condition.
